(19) United States
(12) Patent Application Publication
(10) Pub. No.: US 2006/0113316 A1
(43) Pub. Date: Jun. 1, 2006

(54) Ball storage and dispensing apparatus

(76) Inventor: Michael O. Kilgore SR., Huntsville, AL (US)

Correspondence Address: LANIER FORD SHAVER & PAYNE, P O BOX 2087, HUNTSVILLE, AL, 35804, US

(21) Appl. No.: 10/999,255

(22) Filed: Nov. 30, 2004

(51) Int. Cl. A47F 1/04; G07F 11/16

(52) U.S. Cl. 221/303

(57) ABSTRACT

A ball storage and dispensing apparatus comprising a skeletal support frame having an upper portion and a lower portion. The ball storage and dispensing apparatus is generally configured to correspond to the type of ball to be stored, and preferably arranged and configured to be attached to a goal post or other supporting structure.

### BACKGROUND

1. Field

The present invention relates generally to a ball storage and dispensing device. More specifically, the invention relates to a device for storing and dispensing sports balls.

2. Description of the Related Art

There are several containers and devices in the prior art for storing sports balls, including U.S. Pat. No. 6,267,461, U.S. Pat. No. 5,988,433, U.S. Pat. No. 5,894,951, and U.S. Pat. No. 5,533,646. These prior art patents provide a thorough discussion about the need for ball storage devices and the advantages such storage devices provide. The prior art ball storage devices, however, have a number of limitations and drawbacks, including being heavy and expensive to manufacture. The prior art devices also often include moving parts, locking mechanisms, and other devices unnecessary for normal ball storage. Moreover, a large majority of the prior art ball storage devices are completely enclosed or have structural walls. Thus, the present invention addresses the industry need by providing a simple ball storage and dispensing apparatus that includes no moving parts, is inexpensive to manufacture, and of comparable light weight.

### SUMMARY OF THE INVENTION

The present invention is a ball storage and dispensing apparatus having a skeletal support frame. The skeletal support frame has an upper portion and a lower portion, and, in the preferred embodiment, a transition portion. The lower portion of the skeletal support frame also includes a ball arrester to keep the balls secure until needed by the users.

The apparatus preferably has a mouth in the upper portion of the skeletal support frame and is also preferably configured to substantially correspond to the size and shape of the balls to be stored.

In the preferred embodiment, the ball storage and dispensing apparatus is configured to have a support mount that allows the device to be mounted to a basketball goal support post or a flat surface, such as a wall.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed. It is intended that all obvious features and advantages of the storage and dispensing apparatus as disclosed be included within the scope of the present invention.

### BRIEF DESCRIPTION OF THE DRAWINGS

A full and enabling disclosure of the present invention, including the best mode thereof, directed to one of ordinary skill in the art, is set forth in this specification which makes reference to the appended figures, in which:

FIG. 1 is a side view of a first exemplary embodiment of the ball storage and dispensing apparatus attached to a post.

FIG. 2 is a side view of the embodiment of FIG. 1 of the present invention depicting an angular offset of the separate portions of the apparatus.

FIG. 3 is a front view of the embodiment shown in FIGS. 1 and 2 of the present invention.

FIG. 4 is a perspective view of the ball storage and dispensing apparatus attached to a wall.

Repeated use of reference characters throughout the present specification and appended drawings is intended to represent the same or analogous features or elements of the various embodiments of the present invention described and shown.

### DETAILED DESCRIPTION

With regard to the reference numerals used, the following numbering is used throughout the various drawing figures:
10 ball storage and dispensing apparatus
12 skeletal support frame
14 upper portion of skeletal support frame
16 lower portion of skeletal support frame
18 transition portion of skeletal support frame
20 ball arrestor
22 mouth of skeletal support frame
24 rib members
26 longitudinal support members
28 support mount
30 opening in lower portion of skeletal support frame
32 horizontal axis of upper portion of skeletal support frame
34 horizontal axis of lower portion of skeletal support frame
36 angular offset of horizontal axis of upper portion from horizontal axis of lower portion

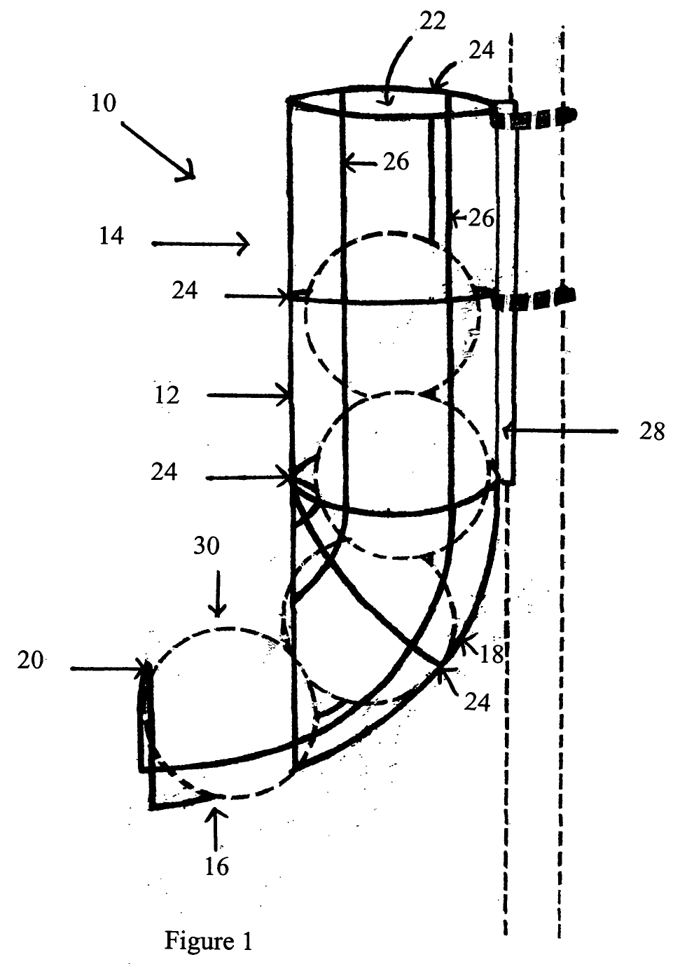

FIG. 1 depicts a first exemplary embodiment of the ball storage and dispensing apparatus, referred to generally with reference numeral 10. The ball storage and dispensing apparatus 10 is defined by a skeletal support frame 12, providing the structural support for the ball storage and dispensing apparatus 10.

The skeletal support frame 12 is generally cylindrical in shape to correspond to the shape of most balls, but can be configured to store and dispense balls of any shape. The skeletal support frame 12 is also generally configured to be slightly larger in diameter than the size of the ball to be stored. In the present embodiment, the skeletal support frame 12 is generally made of wire, however, the support frame 12 can be manufactured using any sufficiently strong material, including but not limited to, heavy plastic, composites, metal strapping, and similar supporting structure. In the present embodiment, the skeletal support frame 12 is substantially rigid, but the skeletal support frame 12 could be non-rigid, in whole or in part.

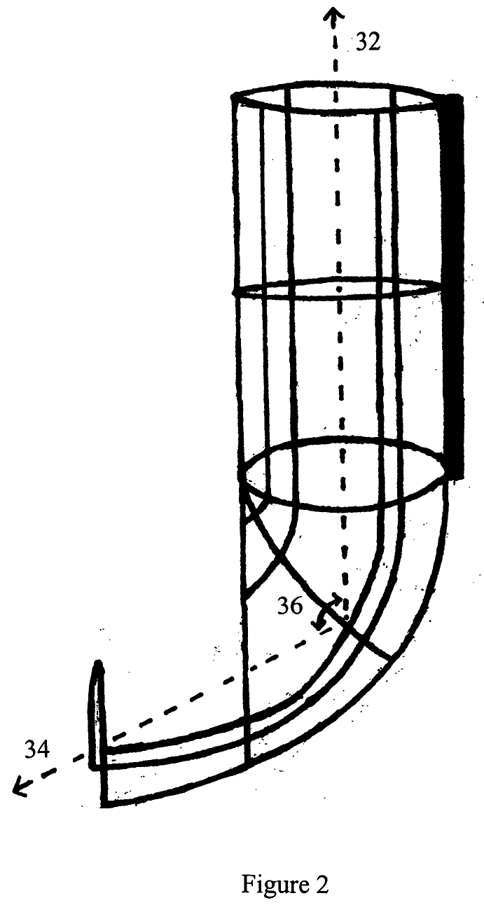

As best seen in FIGS. 1 and 2, the skeletal support frame 12 contains an upper portion 14, a lower portion 16, and a transition portion 18, the upper portion 14 having a horizontal axis 32 and the lower portion 16 having a horizontal axis 34. The upper portion horizontal axis 32 and lower portion horizontal axis 34 preferably have an angular offset 36. The lower portion 16 also preferably includes a ball arrestor 20 to keep the balls secure until needed.

The present embodiment of the ball storage and dispensing apparatus 10 is configured such that the upper portion 14 is substantially vertical. In a substantially vertical position, the weight of the balls being stored will cause the balls to be disposed toward the lower portion 16 of the ball storage and dispensing apparatus 10, and more specifically against the ball arrestor 20. The upper portion 14 has a mouth 22 to allow balls to be easily placed into the ball storage and dispensing apparatus 10.

The ball storage and dispensing apparatus 10 preferably has an opening 30 in the skeletal support frame 12 for users to extract the balls, located in or near the lower portion 16.

In the preferred embodiment, the skeletal support frame 12 is further comprised of a plurality of rib members 24 and longitudinal support members 26, both offering additional structural support to the skeletal support frame 12.

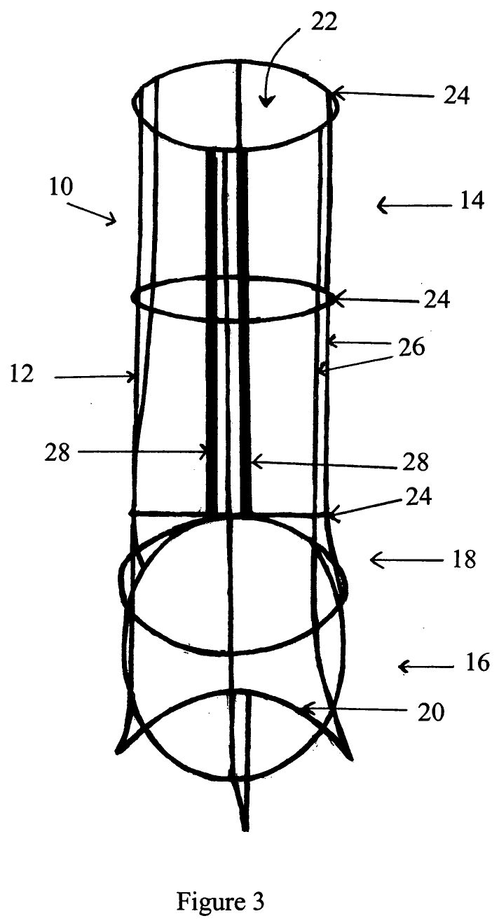

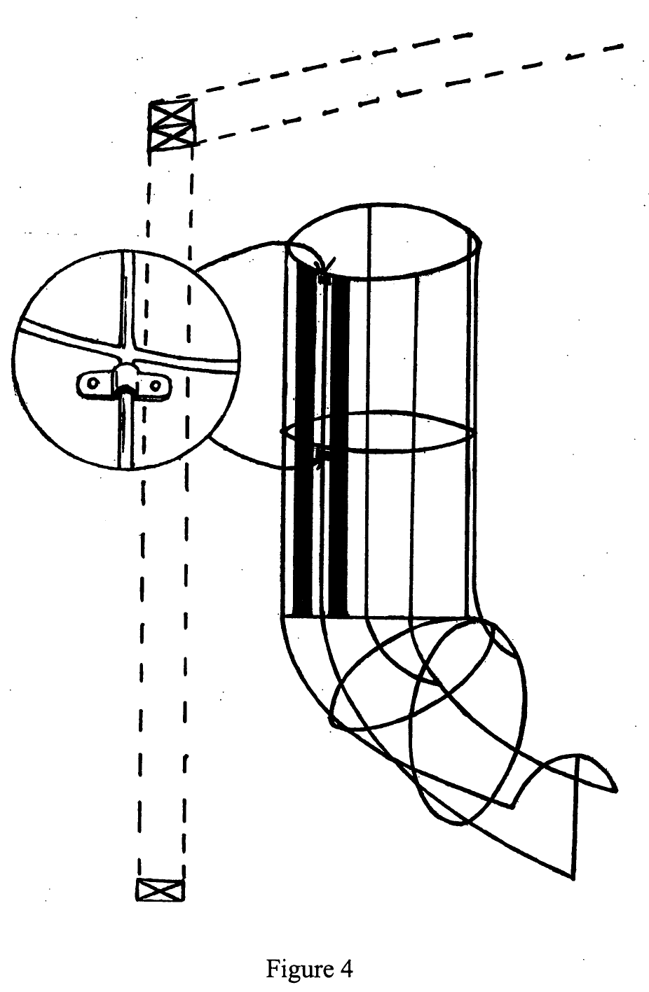

The ball storage and dispensing apparatus 10 is configured so that it may be secured to another object. This can be accomplished by securing the skeletal support frame 12 directly to the object through any conventional means, including through the use of clamps depicted in FIG. 4. The present embodiment of the ball storage and dispensing apparatus 10 includes one or more support mounts 28 which can also be used to secure the apparatus to another object. The support mounts 28 can be integrated with and form part of the skeletal support frame 12 or can be separate. In the present embodiment and as best seen in FIGS. 1 and 3, a plurality of support mounts 28 are attached to, but extend outwardly from, the skeletal support frame 12. In this embodiment, the two support mounts 28 are arranged and configured to correspond to and receive a basketball goal pole or other vertical support means. Still further, and as best seen in FIG. 1, the support mounts 28 may be secured by clamp straps around the vertical support means, although the support mounts 28 can be secured using any conventional means.

In another embodiment depicted in FIG. 4, one or more of the support mounts 28 can be secured directly to a stationary structure, such as a wall. In such an embodiment, the support mounts are configured to have holes through which nails or screws can be driven into the supporting structure.

Other means to secure the ball storage and dispensing apparatus 10 are easily adaptable from other known ball storage devices, for example, those disclosed in U.S. Pat. No. 5,988,433, U.S. Pat. No. 6,267,461, and U.S. Pat. No. 5,894,951, all of which are fully incorporated herein by reference.

What is claimed is:

1. A ball storage device comprising:
(a) an open skeletal support frame having an upper portion with a horizontal axis, a lower portion with a horizontal axis, and a transition portion, wherein the horizontal axis of said upper portion and the horizontal axis of said lower portion are angularly offset; and
(b) a ball arrester disposed on the lower portion of said open skeletal support frame.

2. The ball storage device of claim 1 wherein said open skeletal support frame is configured to generally correspond to the size and shape of the ball to be stored.

3. The ball storage device of claim 1 further comprising a mouth disposed toward the upper portion of the open skeletal support frame, said mouth configured to generally correspond to the size and shape of the ball to be stored.

4. The ball storage device of claim 3 further comprising an opening disposed toward the lower portion of the open skeletal support frame, said opening configured to generally correspond to the shape of the ball to be stored.

5. The ball storage device of claim 1 wherein said open skeletal support frame further comprises a plurality of rib members.

6. The ball storage device of claim 5 wherein said open skeletal support frame further comprises a plurality of longitudinal support members.

7. The ball storage device of claim 6 wherein said upper portion of said open skeletal support frame is generally vertical.

8. The ball storage device of claim 1 wherein the open skeletal support frame is made of wire.

9. The ball storage device of claim 8 wherein the open skeletal support frame is generally rigid.

10. The ball storage device of claim 6 further comprising a support mount.

11. The ball storage device of claim 10 wherein said support mount is configured and arranged to connect to a generally vertical support means.

12. The ball storage device of claim 11 wherein said generally vertical support means is a flat surface.

13. A ball storage device comprising:
a) an open wire skeletal support frame having a plurality of rib members; and
b) a support mount.

14. The ball storage device of claim 13 further comprising of plurality of longitudinal support members.

15. The ball storage device of claim 14 wherein the open wire skeletal support frame has an upper portion with a horizontal axis and a lower portion with a horizontal axis, said upper portion being generally vertical.

16. The ball storage device of claim 15, wherein the horizontal axis of the upper portion is angularly offset from the horizontal axis of the lower portion.

17. The ball storage device of claim 13 wherein said open wire skeletal support frame is generally rigid.

18. The ball storage device of claim 13 wherein said support mount is configured and arranged to connect to a generally vertical support means.

19. A ball storage device comprising:
a) skeletal support frame having an upper portion and a lower portion;
b) a support mount; and
c) an opening disposed toward the lower portion of the skeletal support frame.

20. The ball storage device of claim 19 wherein said skeletal support frame further comprises a plurality of rib members and longitudinal support members.
